(19) United States
(12) Patent Application Publication
(10) Pub. No.: US 2026/0202184 A1
(43) Pub. Date: Jul. 16, 2026

(54) OPTICAL ARRANGEMENT AND CONFOCAL CHROMATIC DISTANCE SENSOR

(71) Applicant: Klingelnberg GmbH, Hückeswagen (DE)

(72) Inventors: Fabian Thönes, Köln (DE); Robin Weber, Hückeswagen (DE); Johann Bergen, Bergneustadt (DE)

(21) Appl. No.: 19/442,606

(22) Filed: Jan. 7, 2026

(30) Foreign Application Priority Data
Jan. 15, 2025 (EP) 25152051.6

(51) Int. Cl. G01B 11/00; G01B 1/00; G02B 6/293; G02B 6/32

(52) U.S. Cl. CPC G01B 11/005; G01B 1/00; G02B 6/29398; G02B 6/32; G01B 2210/50

(57) ABSTRACT

An optical arrangement, wherein a thermally stable axial distance between lenses and an optical fiber holder is specified by way of spacer elements made of a material with a low thermal expansion coefficient than a material of the housing. Resilient compensating elements are provided between axial stops connected to the housing.

### CROSS-REFERENCE TO RELATED APPLICATIONS

This application claims the benefit of European patent application no. 25152051.6, filed on 15 Jan. 2025, the disclosure of which is incorporated herein by reference in its entirety.

### TECHNICAL FIELD

The present disclosure relates to an optical arrangement and a confocal chromatic distance sensor with such an optical arrangement.

### BACKGROUND

A confocal chromatic distance sensor is known, for example, from the patent application with publication number EP 3 611 463 A1 or from the patent application with publication number EP 3 786 573 A1 .

Optical arrangements serve to guide and/or focus light in a targeted manner. For example, an optical arrangement in optical coordinate measurement technology can be used to focus the measuring light of a confocal chromatic distance sensor in the direction of a measurement object and/or to couple light reflected back from the measurement object into an optical fiber in order to evaluate the reflected light spectrally.

In order to achieve reproducible results and high measurement accuracy, it is important that the axial position of the respective optically effective elements, such as lenses, optical fibers, or the like, remains as constant as possible along the optical axis of the optical arrangement so as not to distort the optical image.

Especially in cases where the optical arrangement is not located in a precisely climate-controlled measuring environment, temperature influences can cause thermal expansion of a housing containing the optically effective elements, which can lead to changes in the relative axial positions of the optically effective elements along the optical axis. This can impair the quality of the optical image and distort measurement results.

Against this background, the present disclosure is based on the technical problem of providing an improved optical arrangement that is particularly robust against thermal influences and, in the field of optical coordinate measurement technology, enables reproducible results with high measurement accuracy, especially outside a precisely air-conditioned measuring environment. Furthermore, a confocal chromatic distance sensor with such an optical arrangement is to be provided.

### SUMMARY

The technical problem described above is solved in each case by the features of the independent claims. Further designs of the disclosure are apparent from the dependent claims and the following description.

According to a first aspect, the disclosure relates to an optical arrangement having a first lens, having a second lens, having an optical fiber holder for connecting an optical fiber, and having a housing within which the first lens, the second lens, and the optical fiber holder are arranged, wherein a first spacer element is arranged between the first lens and the second lens to define a first axial distance between the first lens and the second lens measured along an optical axis within the housing, wherein a second spacer element is arranged between the second lens and the optical fiber holder in order to define a second axial distance between the second lens and the optical fiber holder measured along the optical axis within the housing, wherein a first resilient compensating element is provided between a first axial stop connected to the housing and the first lens on a side of the first lens facing away from the second lens, wherein the first compensating element is resiliently elastically pretensioned between the first axial stop and the first lens, wherein a second resilient compensating element is provided between a second axial stop connected to the housing and the optical fiber holder on a side of the optical fiber holder facing away from the second lens, wherein the second compensating element is resiliently elastically pretensioned between the second axial stop and the optical fiber holder, wherein the first spacer element comprises a material having a lower thermal expansion coefficient than a material of the housing, and wherein the second spacer element comprises a material having a lower thermal expansion coefficient than the material of the housing.

The disclosure is based on the idea of decoupling the axial position of the lenses and the optical fiber holder from thermal expansions of the housing by positioning the lenses and the optical fiber axially using spacer elements that have lower thermal expansion coefficients. The resiliently elastic compensating elements can be used to ensure that the lenses and the optical fiber holder continue to be reliably supported at the respective stops despite any temperature-related changes in the length of the housing, as the resiliently elastic compensating elements can compensate for changes in the length of the housing by springing in and out.

This ensures reliable axial positioning of the lenses and the optical fiber holder even under external temperature influences. An improved optical arrangement is therefore provided which is particularly robust against external thermal influences and, in the field of optical coordinate measurement technology, enables reproducible results with high measurement accuracy, especially outside a precisely air-conditioned measurement environment.

The first spacer element may consist of a material that has a lower thermal expansion coefficient than the material of the housing.

The second spacer element may consist of a material that has a lower thermal expansion coefficient than the material of the housing.

The first spacer element may be a circular cylindrical sleeve.

The second spacer element may be a circular cylindrical sleeve.

It may be provided that the first spacer element consists of a composite material, in particular a fiber composite material such as carbon fiber reinforced plastic or the like, and/or that the second spacer element consists of a composite material, in particular a fiber composite material such as carbon fiber reinforced plastic or the like. The first spacer element may be a wound CFRP tube. The abbreviation “CFRP” stands for carbon fiber reinforced plastic.

The first spacer element may have an axial thermal expansion coefficient that is less than or equal to 0.2*10⁻⁶*1/K. The first spacer element may have an axial thermal expansion coefficient that is less than or equal to 0.1*10⁻⁶*1/K.

The first spacer element may have an axial thermal expansion coefficient that is up to five times lower than an axial thermal expansion coefficient of the housing. The first spacer element may have an axial thermal expansion coefficient that is up to ten times lower than an axial thermal expansion coefficient of the housing. The first spacer element may have an axial thermal expansion coefficient that is up to fifteen times lower than an axial thermal expansion coefficient of the housing. The first spacer element may have an axial thermal expansion coefficient that is five to fifteen times lower than an axial thermal expansion coefficient of the housing. The first spacer element may have an axial thermal expansion coefficient that is ten times lower than an axial thermal expansion coefficient of the housing.

It may be provided that the second spacer element consists of a composite material, in particular a fiber composite material such as a carbon fiber reinforced plastic or the like, and/or that the second spacer element consists of a composite material, in particular a fiber composite material such as a carbon fiber reinforced plastic or the like. The second spacer element may be a wound CFRP tube.

The second spacer element may have an axial thermal expansion coefficient that is less than or equal to 0.2*10⁻⁶*1/K. The second spacer element may have an axial thermal expansion coefficient that is less than or equal to 0.1*10⁻⁶*1/K.

The second spacer element may have an axial thermal expansion coefficient that is up to five times lower than an axial thermal expansion coefficient of the housing. The second spacer element may have an axial thermal expansion coefficient that is up to ten times lower than an axial thermal expansion coefficient of the housing. The second spacer element may have an axial thermal expansion coefficient that is up to fifteen times lower than an axial thermal expansion coefficient of the housing. The second spacer element may have an axial thermal expansion coefficient that is five to fifteen times lower than an axial thermal expansion coefficient of the housing. The second spacer element may have an axial thermal expansion coefficient that is ten times lower than an axial thermal expansion coefficient of the housing.

Depending on the design of the optical arrangement, it may be provided that a third spacer element is provided, which is arranged between the second lens and the optical fiber holder in order to define, together with the second spacer element, the second distance between the second lens and the optical fiber holder within the housing, wherein the third spacer element comprises a material that has a lower thermal expansion coefficient than the material of the housing, wherein the third spacer element consists in particular of a composite material, in particular a fiber composite material, such as a carbon fiber reinforced plastic or the like. The third spacer element may be a wound CFRP tube.

The third spacer element may consist of a material that has a lower thermal expansion coefficient than the material of the housing.

The third spacer element may be a circular cylindrical sleeve.

The third spacer element may have an axial thermal expansion coefficient that is less than or equal to 0.2*10⁻⁶*1/K. The third spacer element may have an axial thermal expansion coefficient that is less than or equal to 0.1*10⁻⁶*1/K.

The third spacer element may have an axial thermal expansion coefficient that is up to five times lower than an axial thermal expansion coefficient of the housing. The third spacer element may have an axial thermal expansion coefficient that is up to ten times lower than an axial thermal expansion coefficient of the housing. The third spacer element may have an axial thermal expansion coefficient that is up to fifteen times lower than an axial thermal expansion coefficient of the housing. The third spacer element may have an axial thermal expansion coefficient that is five to fifteen times lower than an axial thermal expansion coefficient of the housing. The third spacer element may have an axial thermal expansion coefficient that is ten times lower than an axial thermal expansion coefficient of the housing.

The material of the housing may have an axial thermal expansion coefficient that is greater than or equal to 1*10⁻⁶*1/K.

It may be provided that the second spacer element is arranged between the second lens and a shoulder of the housing, and the third spacer element is arranged between the optical fiber holder and the shoulder of the housing.

It may be provided that the second spacer element rests against the shoulder and the optical fiber holder rests against the shoulder.

It may be provided that the optical arrangement has exactly two spacer elements.

It may be provided that the optical arrangement has exactly three spacer elements.

According to one design of the optical arrangement, it may be provided that the housing has a first section with a first housing diameter, within which the first lens and the second lens are arranged, and the housing has a second section with a second housing diameter, within which the optical fiber holder is arranged, wherein the first housing diameter is larger than the second housing diameter.

It may be provided that the shoulder forms the transition between the first section and the second section.

According to one design of the optical arrangement, it may be provided that the first axial stop is a nut screwed into the housing.

According to one design of the optical arrangement, it may be provided that the second axial stop may be a nut screwed into the housing.

According to one design of the optical arrangement, it may be provided that the first compensating element may be an elastic plastic component, such as an O-ring or the like.

According to one design of the optical arrangement, it may be provided that the second compensating element may be an elastic plastic component, such as an O-ring or the like.

It may be provided that the first compensating element rests against the first lens. According to alternative designs, it may be provided that a spacer element or a spacer is provided between the first lens and the first compensating element.

It may be provided that the second compensating element rests against the optical fiber holder. According to alternative designs, it may be provided that a spacer element or a spacer is provided between the optical fiber holder and the second compensating element.

It may be provided that the first spacer element rests against the first lens. According to alternative designs, it may be provided that a further spacer element or spacer is provided between the first lens and the first spacer element.

It may be provided that the first spacer element rests against the second lens. According to alternative designs, it may be provided that a further spacer element or spacer is provided between the second lens and the first spacer element.

It may be provided that the second spacer element rests against the second lens. According to alternative designs, it may be provided that a further spacer element or spacer is provided between the second lens and the second spacer element.

It may be provided that at least one spacer element rests against the optical fiber holder. According to alternative designs, it may be provided that a further spacer element or spacer is provided between the optical fiber holder and an associated spacer element.

It may be provided that the housing comprises a metallic material or consists of a metallic material, such as a steel material, an aluminum material, or the like.

It may be provided that the material of the housing has a thermal expansion coefficient that is more than five times the thermal expansion coefficient of the material of the first spacer element and/or the second spacer element, in particular a thermal expansion coefficient that is more than ten times the thermal expansion coefficient of the material of the first spacer element and/or the second spacer element.

According to a second aspect, the disclosure relates to a confocal chromatic distance sensor for distance measurement, having a light source, having an optical arrangement, having an optical fiber, and having a spectrometer, wherein the optical arrangement is connected to the spectrometer by means of the optical fiber and wherein the optical arrangement is designed to focus light reflected from a measurement object into the optical fiber. The distance sensor is characterized in that the optical arrangement is designed in accordance with the disclosure.

It may be provided that the housing is attached to a support structure by means of a bracket, wherein the bracket is spaced apart from the first lens in the axial direction. For example, the bracket may be spaced apart from the first lens in the axial direction by a distance corresponding to more than half of the axial length of the housing.

The arrangement of the bracket at a distance from the first lens has the advantage that a collision with a measurement object can be prevented during the measurement, provided that measurement movements are performed during the measurement.

The support structure can, for example, be part of a CNC-controlled axis of a coordinate measuring machine for gear measurement.

The combination of a bracket spaced from the first lens with the temperature-stable spacer elements has the advantage that the optical arrangement can be fastened or gripped with an axially free-cantilevered housing length without this type of fastening having a negative effect on the measurement result due to thermal expansion of the housing. The bracket, which forms a collision structure during the execution of the measuring movements for CNC-controlled coordinate measurement, can thus be arranged away from the measuring object so that possible measuring movements are restricted by the housing of the optical arrangement but not by the bracket.

For example, it may be provided that the bracket rests against the shoulder of the housing.

### BRIEF DESCRIPTION OF THE DRAWINGS

The disclosure is explained in more detail below with reference to a drawing illustrating an exemplary embodiment. The following figures show schematically:

FIG. 1 shows an optical arrangement according to the disclosure in a partial section;

FIG. 2 shows a further optical arrangement according to the disclosure in a partial section;

FIG. 3 shows another optical arrangement according to the disclosure in a partial section; and

FIG. 4 shows a confocal chromatic distance sensor according to the disclosure for distance measurement.

### DETAILED DESCRIPTION OF THE DRAWINGS

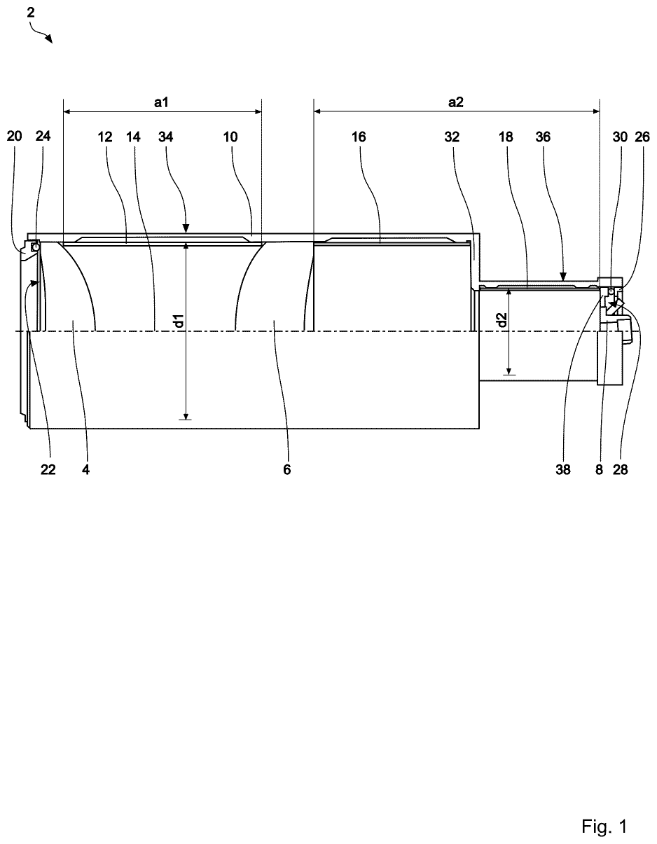

FIG. 1 shows an optical arrangement 2 according to the disclosure in a sectional view.

The optical arrangement 2 has a first lens 4 and a second lens 6.

The optical arrangement 2 has an optical fiber holder 8 for connecting an optical fiber.

The optical arrangement 2 has a housing 10. The first lens 4 and the second lens 6 are arranged inside the housing 10.

A first spacer element 12 is arranged between the first lens 4 and the second lens 6. The spacer element 12 serves to define a first axial distance a1 between the first lens 4 and the second lens 6 within the housing 10, measured along an optical axis 14.

A second spacer element 16 and a third spacer element 18 are arranged between the second lens 6 and the optical fiber holder 8. The second spacer element 16 and the third spacer element 18 serve to define a second axial distance a2 between the second lens 6 and the optical fiber holder 8 within the housing 10, measured along the optical axis 14.

A first resilient compensating element 24 is provided between a first axial stop 20 connected to the housing 10 and the first lens 4 on a side 22 of the first lens 4 facing away from the second lens 6. The first resilient compensating element 24 is resiliently elastic and pretensioned between the first axial stop 20 and the first lens 4. The first compensating element 24 comprises a plastic material.

A second resilient compensating element 30 is provided between a second axial stop 26 connected to the housing 10 and the optical fiber holder 8 on a side 28 of the optical fiber holder 8 facing away from the second lens. The second compensating element 30 is resiliently elastically pretensioned between the second axial stop 26 and the optical fiber holder 8. The second compensating element 30 comprises a plastic material.

The first spacer element 12 consists of a material that has a lower thermal expansion coefficient than a material of the housing 10. The second spacer element 16 consists of a material that has a lower thermal expansion coefficient than the material of the housing 10. The third spacer element 18 consists of a material that has a lower thermal expansion coefficient than the material of the housing 10.

The first spacer element 12, the second spacer element 16, and the third spacer element 18 are each made of a fiber composite material. The first spacer element 12, the second spacer element 16, and the third spacer element 18 are each designed as a wound CFRP tube.

The second spacer element 16 is arranged between the second lens 6 and a shoulder 32 of the housing 10. The third spacer element 18 is arranged between the optical fiber holder 8 and the shoulder 32 of the housing 10. The shoulder 32 serves as a fastening area, wherein the optical arrangement 2 is mounted, in particular clamped, in the area of the shoulder 32 when assembled.

The housing 10 has a first section 34 with a first housing diameter d1, within which the first lens 4 and the second lens 6 are arranged. The housing 10 has a second section 36 with a second housing diameter d2, within which the optical fiber holder 8 is arranged. The first housing diameter d1 is larger than the second housing diameter d2.

The shoulder 32 forms a transition between the first section 34 and the second section 36 of the housing 10.

The first axial stop 20 is a nut screwed into the housing 10.

The second axial stop 26 is a nut screwed into the housing 10.

The first compensating element 24 is an elastic plastic component, specifically an O-ring.

The second compensating element 30 is an elastic plastic component, specifically an O-ring.

The first compensating element 24 rests against the first lens 4. According to alternative exemplary embodiments, a spacer element or spacer may be provided between the first lens 4 and the first compensating element 24.

The second compensating element 30 rests against the optical fiber holder 8. A collar 38 shown in FIG. 1 is part of the optical fiber holder 8. According to alternative exemplary embodiments, a spacer element or spacer may be provided between the optical fiber holder 8 and the second compensating element 30.

The first spacer element 12 rests against the first lens 4. According to alternative exemplary embodiments, a further spacer element or spacer may be provided between the first lens 4 and the first spacer element 12.

The first spacer element 12 rests against the second lens 6. According to alternative exemplary embodiments, a further spacer element or spacer may be provided between the second lens 6 and the first spacer element 12.

The second spacer element 16 rests against the second lens 6. According to alternative exemplary embodiments, a further spacer element or spacer may be provided between the second lens 6 and the second spacer element 16.

The third spacer element 18 rests against the optical fiber holder 8. According to alternative exemplary embodiments, it may be provided that a further spacer element or spacer is provided between the optical fiber holder 8 and the third spacer element 18. According to alternative embodiments, it may be provided that no third spacer element 18 is provided, but that the second spacer element 16 rests against the optical fiber holder 8.

The housing 10 comprises a metallic material, wherein the material of the housing has a thermal expansion coefficient that is ten times that of the thermal expansion coefficient of the material of the spacer elements 12, 16, 18.

The lenses 4, 6 and the optical fiber holder 8 are inserted axially into the housing 10, but are not connected to the housing 10. If the housing 10 heats up and undergoes axial length expansion as a result of the heating, the lenses 4, 6 and the optical fiber holder 8 remain in the same position relative to each other in the axial direction. This is because the compensating elements 24, 30 compensate for the axial expansion of the housing 10 due to their resiliently elastic pretension, so that axial fixation is still ensured. The longitudinal expansion of the spacer elements 12, 16, 18 is negligible due to their low thermal expansion coefficients. This allows a temperature-stable axial arrangement of the lenses 4, 6 and the optical fiber holder 8 with essentially constant axial distances a1, a2 to be specified.

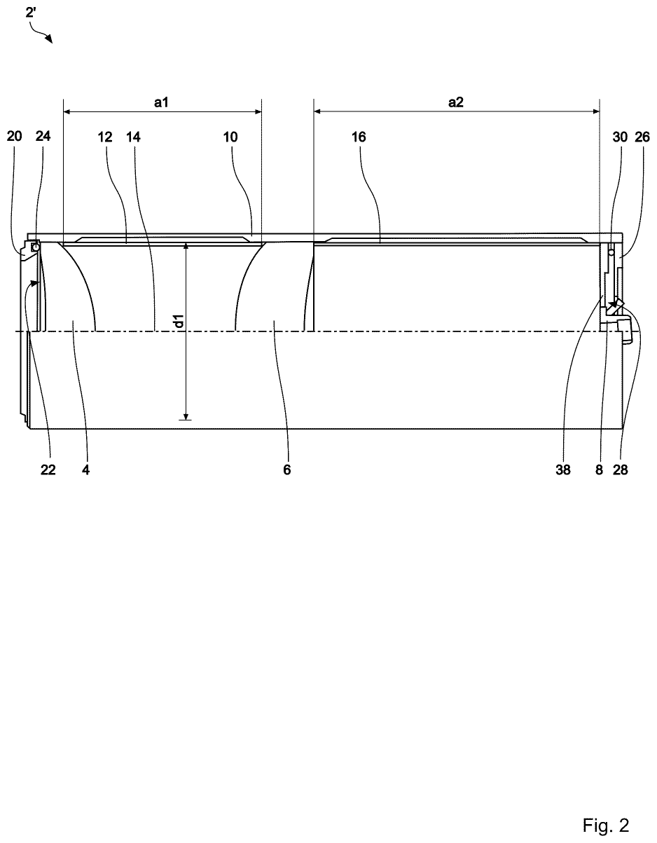

FIG. 2 shows a further design of an optical arrangement 2′ according to the disclosure in a partial section. To avoid repetition, only the differences from the exemplary embodiment described above are discussed, with the same reference signs being assigned to the same features.

The optical arrangement 2′ has only two spacer elements 12, 16 and has a continuously constant housing diameter d1. The collar 38 of the optical fiber holder 8 is dimensioned to correspond to the housing diameter d1. The optical arrangement 2′ has no shoulder 32, so that the second lens 6 and the optical fiber holder 8 rest directly on the second spacer element 16.

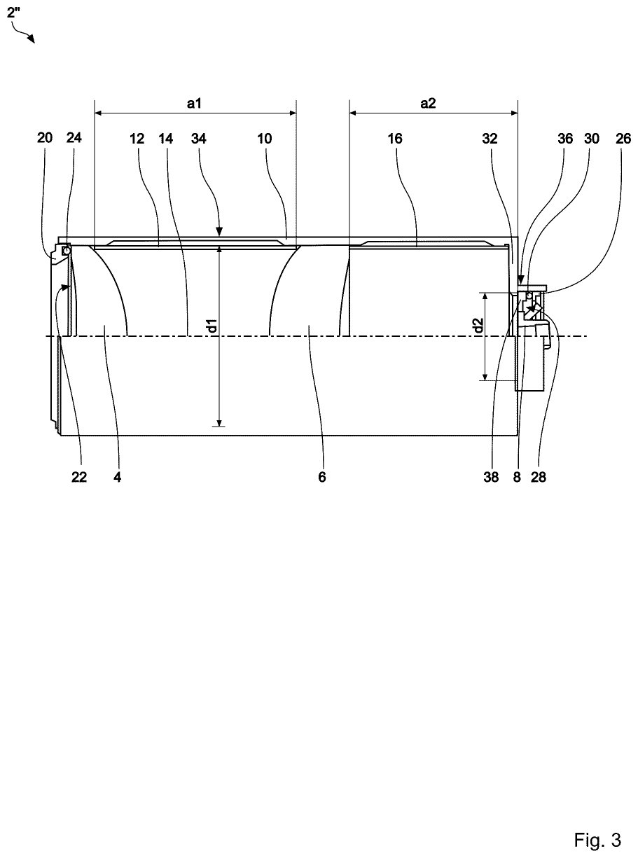

FIG. 3 shows a further design of an optical arrangement 2″ according to the disclosure in a partial section. To avoid repetition, only the differences from the exemplary embodiment described above are discussed, with the same reference signs being assigned to the same features.

The optical arrangement 2″ has only two spacer elements 12, 16, but still has the shoulder 32 and the two housing sections 34, 36 with their different diameters d1, d2. The optical fiber holder 8 rests with its collar 38 directly against the shoulder 32.

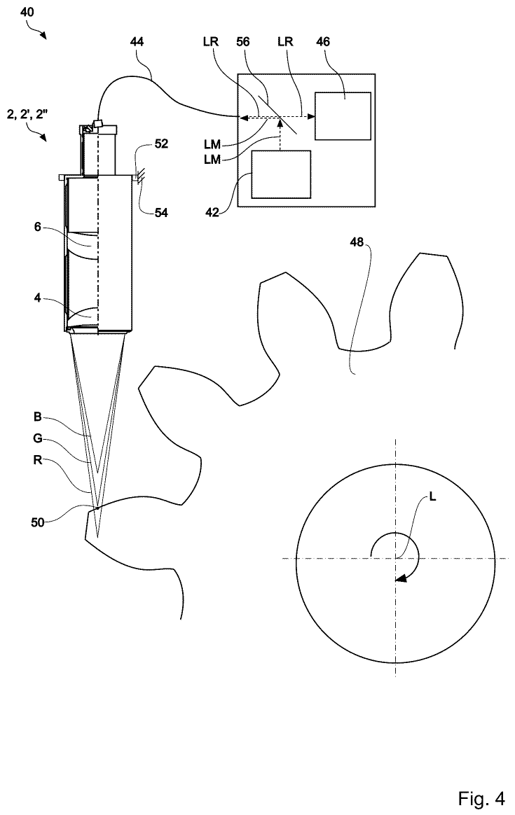

FIG. 4 shows a confocal chromatic distance sensor 40 for distance measurement, having a light source 42, having an optical arrangement 2 according to FIG. 1 or an optical arrangement 2′ according to FIG. 2 or an optical arrangement 2″ according to FIG. 3. The confocal chromatic distance sensor 40 has an optical fiber 44 and a spectrometer 46, wherein the optical arrangement 2 is connected to the spectrometer 46 and the light source 42 by means of the optical fiber 44.

The optical arrangement 2, 2′, 2″ is designed to emit measurement light LM generated by the light source 42 in the direction of a measurement object 48 and to focus light LR reflected back from the measurement object 48 into the optical fiber 44. During the measurement, the measurement object 48 can be rotated about its longitudinal axis L in order to travel a measurement path.

Distance measurement with the confocal chromatic distance sensor 40 works in such a way that the measuring light LM generated by the light source 42 is focused in the direction of the measuring object 48. After passing through the lenses 4, 6, the different light colors or wavelengths B, G, R of the measuring light LM are focused at different distances from the optical arrangement 2, 2′, 2″. This means that light components corresponding to the wavelengths B (blue), G (green), and R (red) are focused at different, known distances from the optical arrangement 2, 2′, 2″.

The distance of a measuring point 50 from the optical arrangement 2 can be determined based on the intensities of the light colors of the light LR reflected back by the component 4, which are detected by the spectrometer 46. In other words, spectral analysis of the reflected light LR using the spectrometer 46 of the confocal chromatic distance sensor 40 allows the position of the optically detected measuring point 50 to be determined. The confocal chromatic distance sensor 40 therefore uses the chromatic aberration of the optical arrangement 2, 2′, 2″ for distance measurement.

A beam splitter 56 is arranged between the light source 42, the spectrometer 46, and the optical fiber 44 in order to direct measurement light LM from the light source 42 toward the optical fiber 44 and to direct reflected light LR toward the spectrometer 46.

The beam splitter 56 may comprise, for example, one or more of the following components/elements: beam splitter plate (e.g., a semi-transparent mirror or a coated (glass) substrate), beam splitter cube (e.g., consisting of two prisms joined together), prism beam splitter, polka dot beam splitter, pellicle beam splitter, reflection beam splitter, grating beam splitter, fiber optic beam splitter, waveguide beam splitter.

The confocal chromatic distance sensor 40 is attached to a support structure 54 by means of a bracket 52. The support structure 54 can, for example, be part of a CNC-controlled axis of a coordinate measuring machine for gear measurement.

Viewed in the axial direction, the bracket 52 is spaced apart from the first lens 4. It applies to all exemplary embodiments that the first lens 4 is arranged on the measurement object side and the second lens 6 is arranged on the sensor side. The arrangement of the bracket 52 with an axial distance from the first lens 4 has the advantage that a collision of the bracket 52 with the measurement object 48 can be prevented during the measurement.

If the optical arrangement of the distance sensor 40 is designed as optical arrangement 2 according to FIG. 1, the bracket 52 rests against the shoulder 32. The spacer elements 12, 16, 18 ensure that thermal axial elongation of the housing has no influence on the relative position of the lenses 4, 6 and the optical fiber holder 8 in relation to each other and to the bracket 52.

1. An optical arrangement comprising:
a first lens, having a second lens, having an optical fiber holder for connecting an optical fiber, and having a housing inside which the first lens, the second lens, and the optical fiber holder are arranged,
wherein a first spacer element is arranged between the first lens and the second lens to define a first axial distance between the first lens and the second lens measured along an optical axis within the housing,
wherein a second spacer element is arranged between the second lens and the optical fiber holder in order to define a second axial distance between the second lens and the optical fiber holder measured along the optical axis within the housing,
wherein a first resilient compensating element is provided between a first axial stop connected to the housing and the first lens on a side of the first lens facing away from the second lens, wherein the first compensating element is resiliently elastically pretensioned between the first axial stop and the first lens,
wherein a second resilient compensating element is provided between a second axial stop connected to the housing and the optical fiber holder on a side of the optical fiber holder facing away from the second lens, wherein the second compensating element is resiliently elastically pretensioned between the second axial stop and the optical fiber holder,
wherein the first spacer element comprises a material having a lower thermal expansion coefficient than a material of the housing, and
wherein the second spacer element comprises a material having a lower thermal expansion coefficient than the material of the housing.

2. The optical arrangement according to claim 1,
wherein the first spacer element comprises a composite material, in particular a fiber composite material, such as a carbon fiber reinforced plastic, and/or
the second spacer element comprises a composite material, in particular a fiber composite material, such as a carbon fiber-reinforced plastic.

3. The optical arrangement according to claim 1,
wherein a third spacer element is provided, which is arranged between the second lens and the optical fiber holder in order to define, together with the second spacer element, the second distance between the second lens and the optical fiber holder within the housing, wherein the third spacer element comprises a material that has a lower thermal expansion coefficient than the material of the housing,
wherein the third spacer element comprises particular of a composite material, in particular a fiber composite material, such as a carbon fiber reinforced plastic.

4. The optical arrangement according to claim 3,
wherein the second spacer element is arranged between the second lens and a shoulder of the housing, and the third spacer element is arranged between the optical fiber holder and the shoulder of the housing.

5. The optical arrangement according to claim 1,
wherein the housing has a first section with a first housing diameter, within which the first lens and the second lens are arranged, and the housing has a second section with a second housing diameter, within which the optical fiber holder is arranged, wherein the first housing diameter is larger than the second housing diameter.

6. The optical arrangement according to claim 4,
wherein the shoulder forms the transition between the first section and the second section.

7. The optical arrangement according to claim 1, wherein
the first axial stop is a nut screwed into the housing, and/or
the second axial stop is a nut screwed into the housing, and/or
the first compensating element is an elastic plastic component, such as an O-ring, and/or
the second compensating element is an elastic plastic component, such as an O-ring.

8. The optical arrangement according to claim 1, wherein
the first compensating element rests against the first lens, and/or
the second compensating element rests against the optical fiber holder, and/or
the first spacer element rests against the first lens and/or
the first spacer element rests against the second lens and/or
the second spacer element rests against the second lens and/or
at least one spacer element rests against the optical fiber holder.

9. The optical arrangement according to claim 1, wherein
the housing comprises a metallic material or consists of a metallic material, and/or
the material of the housing has a thermal expansion coefficient that is more than five times the thermal expansion coefficient of the material of the first spacer element and/or the second spacer element.

10. A confocal chromatic distance sensor for distance measurement, comprising:
light source,
an optical arrangement,
an optical fiber,
spectrometer,
wherein the optical arrangement is connected to the spectrometer by means of the optical fiber,
wherein the optical arrangement is designed to focus light reflected from a measurement object into the optical fiber,
wherein the optical arrangement designed in accordance with claim 1.

11. The confocal chromatic distance sensor according to claim 10, wherein
the housing is attached to a support structure by means of a bracket, wherein the bracket is spaced apart from the first lens in the axial direction.

12. The confocal chromatic distance sensor according to claim 11, wherein an optical arrangement comprises:
a first lens, having a second lens, having an optical fiber holder for connecting an optical fiber, and having a housing inside which the first lens, the second lens, and the optical fiber holder are arranged,
wherein a first spacer element is arranged between the first lens and the second lens to define a first axial distance between the first lens and the second lens measured along an optical axis within the housing,
wherein a second spacer element is arranged between the second lens and the optical fiber holder in order to define a second axial distance between the second lens and the optical fiber holder measured along the optical axis within the housing,
wherein a first resilient compensating element is provided between a first axial stop connected to the housing and the first lens on a side of the first lens facing away from the second lens, wherein the first compensating element is resiliently elastically pretensioned between the first axial stop and the first lens,
wherein a second resilient compensating element is provided between a second axial stop connected to the housing and the optical fiber holder on a side of the optical fiber holder facing away from the second lens, wherein the second compensating element is resiliently elastically pretensioned between the second axial stop and the optical fiber holder,
wherein the first spacer element comprises a material having a lower thermal expansion coefficient than a material of the housing, and
wherein the second spacer element comprises a material having a lower thermal expansion coefficient than the material of the housing, wherein the housing has a first section with a first housing diameter, within which the first lens and the second lens are arranged, and the housing has a second section with a second housing diameter, within which the optical fiber holder is arranged, wherein the first housing diameter is larger than the second housing diameter, wherein the bracket rests against the shoulder.
